(19) United States
(12) Patent Application Publication
(10) Pub. No.: US 2025/0093283 A1
(43) Pub. Date: Mar. 20, 2025

(54) X-RAY INSPECTION DEVICE AND CALIBRATION METHOD THEREOF

(71) Applicant: ANRITSU CORPORATION, Kanagawa (JP)

(72) Inventor: Akira OHASHI, Kanagawa (JP)

(21) Appl. No.: 18/883,429

(22) Filed: Sep. 12, 2024

(30) Foreign Application Priority Data
Sep. 20, 2023 (JP) 2023-152315

(51) Int. Cl. G01N 23/083; G01N 23/04

(52) U.S. Cl. CPC G01N 23/083; G01N 23/04; G01N 2223/204; G01N 2223/303; G01N 2223/401; G01N 2223/50; G01N 2223/643

(57) ABSTRACT

An X-ray inspection device includes an X-ray detection element that outputs a pulse signal with a peak value corresponding to an energy of an X-ray passing through an inspection region, an X-ray detection unit consisting of a plurality of pixels that detect the number of the pulse signals exceeding a predetermined threshold voltage, among the pulse signals output from the X-ray detection element, a storage unit that stores, for each pixel, a correspondence relationship between a value of a control parameter to cause the number of the pulse signals exceeding the threshold voltage to change and the number of the pulse signals detected by respective pixels, and an output unit that outputs abnormal pixel information based on the correspondence relationship between the value of the control parameter and the number of the pulse signals detected by respective pixels, the correspondence relationship being read out from the storage unit.

### TECHNICAL FIELD

The present invention relates to an X-ray inspection device and a calibration method thereof that inspect an inspection object with irradiation of the inspection object with an X-ray and based on a transmission amount of the X-ray.

### BACKGROUND ART

An X-ray inspection device irradiates, with an X-ray, an inspection object, such as meat, fish, processed food, or a pharmaceutical product, which is sequentially transported at a predetermined interval on a transport path, to inspect whether a foreign matter is contained into the inspection object, whether the inspection object is defective, or the like based on a transmission amount of the irradiated X-ray.

The X-ray inspection device is incorporated into an inspection line, which performs, for example, an inspection for foreign matter contamination or a final weight inspection, to perform the inspection for foreign matter contamination or the like.

In the X-ray inspection device, the transport path of the inspection object is irradiated with X-rays having a width in a direction orthogonal to a transport direction of the inspection object. The X-rays transmitted through the inspection object are received by a plurality of sensor elements (pixels) arranged in the direction orthogonal to the transport direction of the inspection object to obtain image information representing, as a contrast, a difference in a transmittance of each portion of the inspection object to the X-ray. Various types of processing are performed on the image information to determine whether or not the foreign matter is contained or whether or not there is a defect, a shortage, or the like in contents.

However, in such an X-ray inspection device, the X-rays are emitted to spread in the direction orthogonal to the transport direction, and thus intensity of the X-ray incident on each pixel is not uniform due to a difference in a distance from an X-ray source to each pixel.

Patent Document 1 discloses an X-ray inspection device that uses a calibration member to change incidence conditions of X-rays common to all pixels into two or more types and obtains, for each incidence condition changed by the calibration member, calibration data necessary for making image data have a uniform density.

### RELATED ART DOCUMENT

### Patent Document

[Patent Document 1] Japanese Patent No. 6717784

### DISCLOSURE OF THE INVENTION

### Problem that the Invention is to Solve

However, in the X-ray inspection device in the related art, there is a problem in that, in a case where there is a pixel with a sensitivity deviating significantly from an average sensitivity among a plurality of pixels, the density of the image data cannot be sufficiently calibrated.

The present invention has been made to solve such a problem in the related art, and an object of the present invention is to provide an X-ray inspection device and a calibration method thereof capable of outputting abnormal pixel information for specifying an abnormal pixel among a plurality of pixels constituting an X-ray detector.

### Means for Solving the Problem

In order to solve the above problems, according to a first aspect of the present invention, there is provided an X-ray inspection device including an X-ray generation source that irradiates an inspection region with an X-ray, an X-ray detector that detects the X-ray passing through the inspection region, the X-ray detector including an X-ray detection element that outputs a pulse signal with a peak value corresponding to an energy of the X-ray passing through the inspection region and an X-ray detection unit consisting of a plurality of pixels that detect the number of the pulse signals exceeding a predetermined threshold voltage, among the pulse signals output from the X-ray detection element, a storage unit that stores, for each pixel, a correspondence relationship between a value of a control parameter to cause the number of the pulse signals exceeding the threshold voltage to change and the number of the pulse signals detected by respective pixels, and an abnormal pixel information output unit that outputs abnormal pixel information to specify an abnormal pixel based on the correspondence relationship between the value of the control parameter and the number of the pulse signals detected by respective pixels, the correspondence relationship being read out from the storage unit.

Accordingly, the X-ray inspection device according to the first aspect of the present invention acquires the correspondence relationship between the value of the control parameter to cause the number of the pulse signals exceeding the predetermined threshold voltage to change, among the pulse signals with the peak value corresponding to the energy of the X-ray passing through the inspection region, and the number of pulse signals detected by respective pixels of the X-ray detection unit. Further, the X-ray inspection device according to the first aspect of the present invention can output the abnormal pixel information to specify the abnormal pixel based on the correspondence relationship between the value of the control parameter and the number of pulse signals detected by respective pixels.

Further, according to a second aspect of the present invention, there is provided an X-ray inspection device including an X-ray generation source that irradiates an inspection region with an X-ray, an X-ray detector that detects the X-ray passing through the inspection region, a display unit that displays various types of information, and an input/output unit that is connectable to an external device, in which wherein the X-ray detector includes an X-ray detection element that outputs a pulse signal with a peak value corresponding to an energy of the X-ray passing through the inspection region, an X-ray detection unit consisting of a plurality of pixels that detect the number of the pulse signals exceeding a predetermined threshold voltage, among the pulse signals output from the X-ray detection element, and a control parameter control unit that performs control of changing a value of a control parameter to cause the number of the pulse signals exceeding the threshold voltage to change, and the external device includes a storage unit that stores, for each pixel, a correspondence relationship between the value of the control parameter controlled by the control parameter control unit and the number of the pulse signals detected by respective pixels, which is input via the input/output unit, and an abnormal pixel information output unit that generates abnormal pixel information to specify an abnormal pixel, based on the correspondence relationship between the value of the control parameter and the number of the pulse signals detected by respective pixels, the correspondence relationship being read out from the storage unit, and outputs the abnormal pixel information to the display unit via the input/output unit.

Accordingly, in the X-ray inspection device according to the second aspect of the present invention, in a case where the storage unit and the abnormal pixel information output unit are provided in the external device, the external device may be connected via the input/output unit only in a case where the abnormal pixel is specified at a time of product shipment, and thus it is possible to simplify a device main body.

Further, according to a third aspect of the present invention, in the X-ray inspection device according to the first aspect, the control parameter may be the threshold voltage or a tube voltage of the X-ray generation source. Further, according to a fourth aspect of the present invention, in the X-ray inspection device according to the second aspect, the control parameter may be the threshold voltage or a tube voltage of the X-ray generation source.

Further, according to a fifth aspect of the present invention, in the X-ray inspection device according to the first aspect, the control parameter may be any one of the threshold voltage, a tube voltage of the X-ray generation source, or a type of a radiation quality variable body set up in the inspection region. Further, according to a sixth aspect of the present invention, in the X-ray inspection device according to the second aspect, the control parameter may be any one of the threshold voltage, a tube voltage of the X-ray generation source, or a type of a radiation quality variable body set up in the inspection region.

Further, according to a seventh aspect of the present invention, in the X-ray inspection device according to the fifth aspect, the control parameter may be the threshold voltage, and the radiation quality variable body may have a known absorption edge. The X-ray inspection device may further include a control parameter value specifying unit that specifies, for each pixel, the threshold voltage at which an inclination of the number of the pulse signals detected by respective pixels, which is read out from the storage unit, with respect to the control parameter changes discontinuously, and a calibration information output unit that outputs the threshold voltage specified by the control parameter value specifying unit in association with the known absorption edge, as calibration information for respective pixels.

With this configuration, the X-ray inspection device according to the seventh aspect of the present invention can output the threshold voltage, at which the inclination of the number of pulse signals detected by respective pixels with respect to the control parameter discontinuously changes, in association with the known absorption edge, as the calibration information for respective pixels, using the radiation quality variable body having the known absorption edge.

Further, according to an eighth aspect of the present invention, in the X-ray inspection device according to the sixth aspect, the control parameter may be the threshold voltage, and the radiation quality variable body may have a known absorption edge. The X-ray inspection device may further include a control parameter value specifying unit that specifies, for each pixel, the threshold voltage at which an inclination of the number of the pulse signals detected by respective pixels, which is read out from the storage unit, with respect to the control parameter changes discontinuously, and a calibration information output unit that outputs the threshold voltage specified by the control parameter value specifying unit in association with the known absorption edge, as calibration information for respective pixels.

With this configuration, the X-ray inspection device according to the eighth aspect of the present invention can output the threshold voltage, at which the inclination of the number of pulse signals detected by respective pixels with respect to the control parameter discontinuously changes, in association with the known absorption edge, as the calibration information for respective pixels, using the radiation quality variable body having the known absorption edge.

Further, according to a ninth aspect of the present invention, in the X-ray inspection device according to the third aspect, the control parameter may be the threshold voltage. The X-ray inspection device may further include a control parameter value specifying unit that specifies, for each pixel, a minimum threshold voltage at which the number of pulse signals detected by respective pixels, which is read out from the storage unit, is smaller than a predetermined value, and a calibration information output unit that outputs the threshold voltage specified by the control parameter value specifying unit in association with the tube voltage, as calibration information for respective pixels.

With this configuration, the X-ray inspection device according to the ninth aspect of the present invention can output the minimum threshold voltage, at which the number of pulse signals detected by respective pixels is smaller than the predetermined value and is substantially zero, in association with the tube voltage of the X-ray generation source, as the calibration information for respective pixels.

Further, according to a tenth aspect of the present invention, in the X-ray inspection device according to the fourth aspect, the control parameter may be the threshold voltage. The X-ray inspection device may further include a control parameter value specifying unit that specifies, for each pixel, a minimum threshold voltage at which the number of pulse signals detected by respective pixels, which is read out from the storage unit, is smaller than a predetermined value, and a calibration information output unit that outputs the threshold voltage specified by the control parameter value specifying unit in association with the tube voltage, as calibration information for respective pixels.

With this configuration, the X-ray inspection device according to the tenth aspect of the present invention can output the minimum threshold voltage, at which the number of pulse signals detected by respective pixels is smaller than the predetermined value and is substantially zero, in association with the tube voltage of the X-ray generation source, as the calibration information for respective pixels.

Further, according to an eleventh aspect of the present invention, in the X-ray inspection device according to the third aspect, the control parameter may be the tube voltage. The X-ray inspection device may further include a control parameter value specifying unit that specifies, for each pixel, a maximum tube voltage at which the number of pulse signals detected by respective pixels, which is read out from the storage unit, is smaller than a predetermined value, and a calibration information output unit that outputs the tube voltage specified by the control parameter value specifying unit in association with the threshold voltage, as calibration information for respective pixels.

With this configuration, the X-ray inspection device according to the eleventh aspect of the present invention can output the maximum tube voltage of the X-ray generation source, at which the number of pulse signals detected by respective pixels is smaller than the predetermined value and is substantially zero, in association with the threshold voltage, as the calibration information for respective pixels.

Further, according to a twelfth aspect of the present invention, in the X-ray inspection device according to the fourth aspect, the control parameter may be the tube voltage. The X-ray inspection device may further include a control parameter value specifying unit that specifies, for each pixel, a maximum tube voltage at which the number of pulse signals detected by respective pixels, which is read out from the storage unit, is smaller than a predetermined value, and a calibration information output unit that outputs the tube voltage specified by the control parameter value specifying unit in association with the threshold voltage, as calibration information for respective pixels.

With this configuration, the X-ray inspection device according to the twelfth aspect of the present invention can output the maximum tube voltage of the X-ray generation source, at which the number of pulse signals detected by respective pixels is smaller than the predetermined value and is substantially zero, in association with the threshold voltage, as the calibration information for respective pixels.

Further, according to a thirteenth aspect of the present invention, in the X-ray inspection device according to the fifth aspect, the control parameter may be the tube voltage. The X-ray inspection device may further include a control parameter value specifying unit that specifies, for each pixel, a maximum tube voltage at which the number of pulse signals detected by respective pixels, which is read out from the storage unit, is smaller than a predetermined value, and a calibration information output unit that outputs the tube voltage specified by the control parameter value specifying unit in association with the threshold voltage, as calibration information for respective pixels.

With this configuration, the X-ray inspection device according to the thirteenth aspect of the present invention can output the maximum tube voltage of the X-ray generation source, at which the number of pulse signals detected by respective pixels is smaller than the predetermined value and is substantially zero, in association with the threshold voltage, as the calibration information for respective pixels.

Further, according to a fourteenth aspect of the present invention, in the X-ray inspection device according to the sixth aspect, the control parameter may be the tube voltage. The X-ray inspection device may further include a control parameter value specifying unit that specifies, for each pixel, a maximum tube voltage at which the number of pulse signals detected by respective pixels, which is read out from the storage unit, is smaller than a predetermined value, and a calibration information output unit that outputs the tube voltage specified by the control parameter value specifying unit in association with the threshold voltage, as calibration information for respective pixels.

With this configuration, the X-ray inspection device according to the fourteenth aspect of the present invention can output the maximum tube voltage of the X-ray generation source, at which the number of pulse signals detected by respective pixels is smaller than the predetermined value and is substantially zero, in association with the threshold voltage, as the calibration information for respective pixels.

Further, according to a fifteenth aspect of the present invention, there is provided a calibration method of an X-ray inspection device including an X-ray generation source that irradiates an inspection region with an X-ray, and an X-ray detector that detects the X-ray passing through the inspection region, the X-ray detector including an X-ray detection element that outputs a pulse signal with a peak value corresponding to an energy of the X-ray passing through the inspection region and an X-ray detection unit consisting of a plurality of pixels that detect the number of the pulse signals exceeding a predetermined threshold voltage, among the pulse signals output from the X-ray detection element, the calibration method including a step of irradiating the inspection region with the X-ray, an X-ray detection step of detecting the X-ray passing through the inspection region, a storage step of storing, for each pixel, a correspondence relationship between a value of a control parameter to cause the number of the pulse signals exceeding the threshold voltage to change and the number of the pulse signals detected by respective pixels, in a storage unit, and an abnormal pixel information output step of outputting abnormal pixel information to specify an abnormal pixel based on the correspondence relationship between the value of the control parameter and the number of the pulse signals detected by respective pixels, the correspondence relationship being read out from the storage unit.

Accordingly, in the calibration method according to the fifteenth aspect of the present invention, the correspondence relationship between the value of the control parameter to cause the number of the pulse signals exceeding the predetermined threshold voltage to change, among the pulse signals with the peak value corresponding to the energy of the X-ray passing through the inspection region, and the number of pulse signals detected by respective pixels of the X-ray detection unit is acquired. Further, in the calibration method according to the fifteenth aspect of the present invention, the abnormal pixel information to specify the abnormal pixel, based on the correspondence relationship between the value of the control parameter and the number of pulse signals detected by respective pixels, can be output.

Further, according to a sixteenth aspect of the present invention, there is provided a calibration method of an X-ray inspection device including an X-ray generation source that irradiates an inspection region with an X-ray, and an X-ray detector that detects the X-ray passing through the inspection region, in which the X-ray detector includes an X-ray detection element that outputs a pulse signal with a peak value corresponding to an energy of the X-ray passing through the inspection region, and an X-ray detection unit consisting of a plurality of pixels that detect the number of the pulse signals exceeding a predetermined threshold voltage, among the pulse signals output from the X-ray detection element, the calibration method including a step of setting up a radiation quality variable body having a known absorption edge in the inspection region, a step of irradiating the inspection region with the X-ray, an X-ray detection step of detecting the X-ray passing through the inspection region, a storage step of storing, for each pixel, a correspondence relationship between a value of a control parameter to cause the number of the pulse signals exceeding the threshold voltage to change and the number of the pulse signals detected by respective pixels, in a storage unit, a control parameter value specifying step of specifying, for each pixel, the threshold voltage at which an inclination of the number of the pulse signals detected by respective pixels, which is read out from the storage unit, with respect to the control parameter changes discontinuously, and a calibration information output step of outputting the threshold voltage specified in the control parameter value specifying step in association with the known absorption edge, as calibration information for respective pixels.

Further, according to a seventeenth aspect of the present invention, in the calibration method according to the fifteenth aspect, the control parameter may be any of the threshold voltage, a tube voltage of the X-ray generation source, or a type of a radiation quality variable body set up in the inspection region. Further, according to an eighteenth aspect of the present invention, in the calibration method according to the sixteenth aspect, the control parameter may be any of the threshold voltage, a tube voltage of the X-ray generation source, or a type of a radiation quality variable body set up in the inspection region.

Further, according to a nineteenth aspect of the present invention, in the calibration method according to the seventeenth aspect, the control parameter may be the threshold voltage, and the radiation quality variable body may have a known absorption edge. The calibration method may further include a control parameter value specifying step of specifying, for each pixel, the threshold voltage at which an inclination of the number of the pulse signals detected by respective pixels, which is read out from the storage unit, with respect to the control parameter changes discontinuously, and a calibration information output step of outputting the threshold voltage specified in the control parameter value specifying step in association with the known absorption edge, as calibration information for respective pixels.

With this configuration, the calibration method according to the nineteenth aspect of the present invention can output the threshold voltage, at which the inclination of the number of pulse signals detected by respective pixels with respect to the control parameter discontinuously changes, in association with the known absorption edge, as the calibration information for respective pixels, using the radiation quality variable body having the known absorption edge.

Further, according to a twentieth aspect of the present invention, in the calibration method according to the eighteenth aspect, the control parameter may be the threshold voltage, and the radiation quality variable body may have a known absorption edge. The calibration method may further include a control parameter value specifying step of specifying, for each pixel, the threshold voltage at which an inclination of the number of the pulse signals detected by respective pixels, which is read out from the storage unit, with respect to the control parameter changes discontinuously, and a calibration information output step of outputting the threshold voltage specified in the control parameter value specifying step in association with the known absorption edge, as calibration information for respective pixels.

With this configuration, the calibration method according to the twentieth aspect of the present invention can output the threshold voltage, at which the inclination of the number of pulse signals detected by respective pixels with respect to the control parameter discontinuously changes, in association with the known absorption edge, as the calibration information for respective pixels, using the radiation quality variable body having the known absorption edge.

### Advantage of the Invention

An object of the present invention is to provide the X-ray inspection device and the calibration method thereof capable of outputting the abnormal pixel information to specify the abnormal pixel among the plurality of pixels constituting the X-ray detector.

### BRIEF DESCRIPTION OF THE DRAWINGS

FIG. 1 is a schematic configuration diagram of an X-ray inspection device according to an embodiment of the present invention.

FIG. 2 is a diagram for describing a detection principle of the X-ray inspection device of FIG. 1.

FIG. 3A is a perspective view of a main part of an X-ray detector provided in the X-ray inspection device of FIG. 1, and FIG. 3B is a side view of the main part of the X-ray detector.

FIG. 4A is a graph schematically showing an energy distribution of X-rays output from an X-ray generation source provided in the X-ray inspection device of FIG. 1, FIG. 4B is a graph schematically showing a pulse signal input to each pulse detection circuit of the X-ray detector and a threshold voltage, and FIG. 4C is a graph schematically showing an X-ray detection amount obtained by sweeping the threshold voltage.

FIG. 5A is a graph schematically showing an X-ray transmittance of a PET resin, and FIG. 5B is a graph schematically showing the X-ray transmittance of barium.

FIG. 6 is a graph schematically showing the energy distribution (broken line) of the X-rays output from the X-ray generation source and an energy distribution (solid line) of the X-rays output from the X-ray generation source and transmitted through a barium-containing resin plate.

FIG. 7A is a graph schematically showing the X-ray detection amount in a case where the barium-containing resin plate is not set up in an inspection region, and FIG. 7B is a graph schematically showing the X-ray detection amount in a case where the barium-containing resin plate is set up in the inspection region.

FIG. 8 is a schematic configuration diagram showing another configuration example of the X-ray inspection device according to the embodiment of the present invention.

FIG. 9 is a flowchart (part 1) showing processing of a calibration method using the X-ray inspection device of FIG. 1.

FIGS. 10A and 10B are graphs schematically showing a correspondence relationship between the threshold voltage and the X-ray detection amount, which is obtained by the processing of FIG. 9. FIG. 10A shows a case where the barium-containing resin plate is set up in the inspection region, and FIG. 10B shows a case where the barium-containing resin plate is not set up in the inspection region.

FIG. 11 is a flowchart (part 2) showing the processing of the calibration method using the X-ray inspection device of FIG. 1.

FIG. 12 is a graph schematically showing a correspondence relationship between a tube voltage and the X-ray detection amount, which is obtained by the processing of FIG. 11.

FIG. 13 is a flowchart (part 3) showing the processing of the calibration method using the X-ray inspection device of FIG. 1.

FIG. 14 is a graph schematically showing a correspondence relationship between a type of a radiation quality variable body and the X-ray detection amount, which is obtained by the processing of FIG. 13.

FIG. 15 shows an example of a table displayed on a display unit provided in the X-ray inspection device of FIG. 1.

FIG. 16 shows an example of a graph displayed on the display unit.

FIG. 17 is a diagram for describing a clustering method by an abnormal pixel specifying unit provided in the X-ray inspection device of FIG. 1.

FIG. 18 is a graph for describing a method by which a control parameter value specifying unit provided in the X-ray inspection device of FIG. 1 specifies a threshold voltage corresponding to an absorption edge of the radiation quality variable body.

### BEST MODE FOR CARRYING OUT THE INVENTION

Hereinafter, embodiments of an X-ray inspection device and a calibration method thereof according to the present invention will be described with reference to drawings.

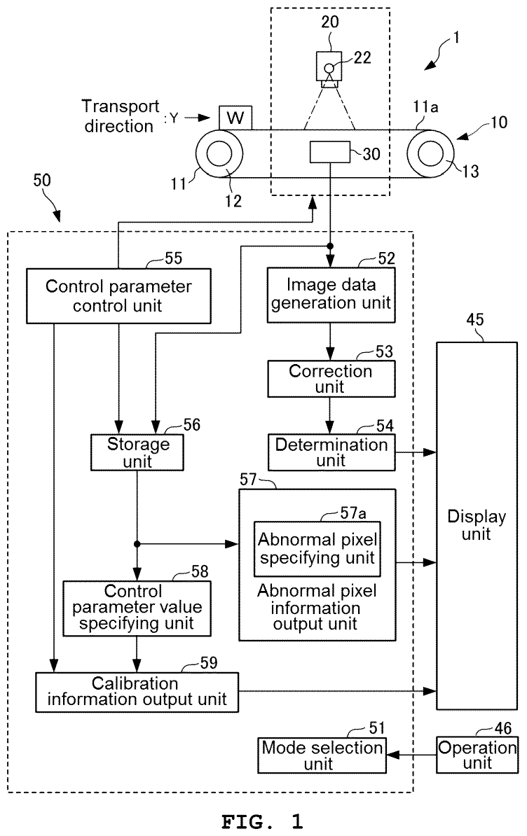

As shown in FIG. 1, an X-ray inspection device 1 according to the present embodiment includes a transport unit 10, an X-ray generation source 20, an X-ray detector 30, and a control unit 50 having a display unit 45 and an operation unit 46.

The transport unit 10 is a belt conveyor in which a loop-shaped transport belt 11 is wound around a plurality of transport rollers 12 and 13 to enable an inspection object W to be inspected, which is placed on a transport surface 11a of the transport belt 11, to be sequentially transported in a transport direction Y and pass through a predetermined inspection region. The transport unit 10 is supported by a housing (not shown).

The transport belt 11 consists of a material (element other than an element with a large atomic mass) that easily transmits an X-ray. In the transport unit 10, in a case where the inspection object W is inspected, rotation of a drive motor is controlled to be a transport speed, which is set in advance by the operation unit 46, to drive the transport belt. Accordingly, the inspection object W transported from a transport inlet is transported toward a transport outlet side in the transport direction Y of FIG. 1 at the set transport speed.

The transport unit 10 is not limited to the belt conveyor that horizontally transports the inspection object W at a constant speed, but may also include any form in which the inspection object W is transported such that the inspection object W is uniformly irradiated with X-rays from the X-ray generation source 20 and the X-rays transmitted through the inspection object W are detected by the X-ray detector 30. For example, a form in which the inspection object W is caused to slide down an inclined path using a weight of the inspection object W, a form in which the inspection object W is dropped from above, or the like may be employed.

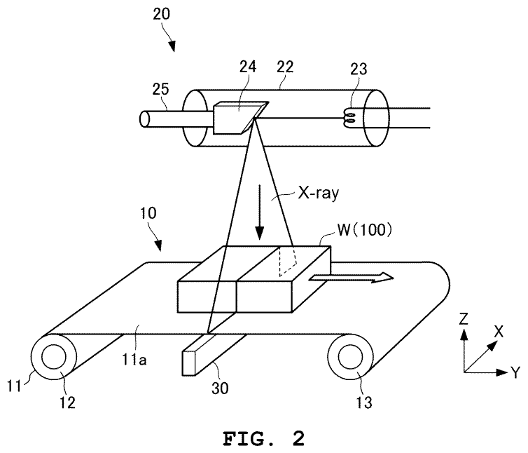

As shown in FIG. 2, the X-ray generation source 20 irradiates, with the X-ray, the inspection region through which the inspection object W, which is transported on a transport path in the transport direction Y from the transport inlet toward the transport outlet, passes. Further, in a calibration mode described below, a radiation quality variable body 100 is set up in the inspection region instead of the inspection object W.

The X-ray generation source 20 has a configuration in which a cylindrical X-ray tube 22 is immersed in insulating oil (not shown). Specifically, a target 24 of an anode 25 is irradiated with an electron beam from a filament 23 provided in a cathode of the X-ray tube 22 to generate the X-ray. The X-ray tube 22 is disposed such that a longitudinal direction of the X-ray tube 22 aligns with the transport direction Y of the inspection object W. The X-rays generated by the X-ray tube 22 are emitted toward the X-ray detector 30 below the transport unit 10 in a substantially triangular screen shape by a slit (not shown) to cross the transport direction Y.

Next, the X-ray detector 30 according to the present embodiment, which detects the X-ray passing through the inspection region, will be described.

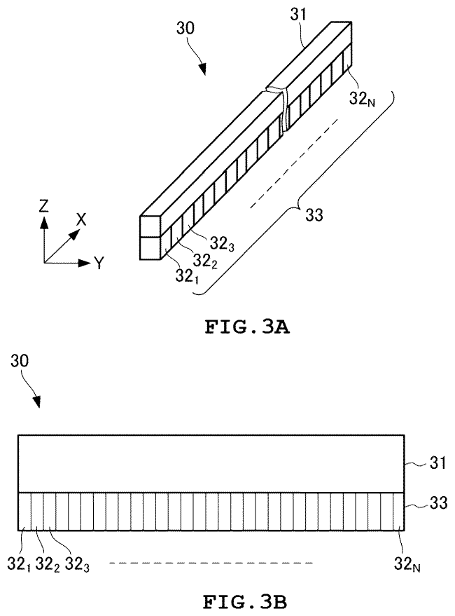

FIG. 3A is a perspective view of a main part of the X-ray detector 30 according to the present embodiment, and FIG. 3B is a side view of the main part thereof. The X-ray detector 30 is configured of, for example, a photon detection type sensor such as a CdTe semiconductor detector, and includes an X-ray detection element 31 and a pulse detection circuit array 33 as shown in FIGS. 3A and 3B. The X-ray detection element 31 may be a substance that outputs a pulse signal with a peak value proportional to an energy of an incident X-ray that passes through the inspection region, and consists of, for example, a semiconductor material such as cadmium telluride (CdTe).

In the pulse detection circuit array 33, a plurality of pulse detection circuits 321, 322, . . . , and 32N that detect the number of pulse signals exceeding a predetermined threshold voltage, among pulse signals output from the X-ray detection element 31, are arranged, for example, in a straight line shape.

Here, N is a total number of pulse detection circuits 32. Each pulse detection circuit 32 constitutes a single pixel. Specifically, the X-ray detector 30 is disposed along an X direction orthogonal to the transport direction Y of the inspection object W below the transport surface 11a on which the inspection object W is transported (refer to FIG. 2). The pulse detection circuit array 33 of the present embodiment corresponds to an X-ray detection unit of the present invention.

The control unit 50 can set various threshold voltages in each pulse detection circuit 32. The peak value of the pulse signal input to the pulse detection circuit array 33 is proportional to the energy of the incident X-ray.

Physical quantities representing intensity of the X-ray include the energy (wavelength) and intensity (number of photons) of the X-ray. The energy of the X-ray is represented in units of [eV]. The energy of the X-ray is decided by a tube voltage of the X-ray tube 22 and a material of the target 24 at a time of X-ray generation, and is generated with a continuous distribution. The intensity of the X-ray is represented in units of [cps](the number of photons per second).

The intensity of the X-ray changes with a change in a tube current of the X-ray tube 22, but the energy of the X-ray does not change.

That is, the number of pulse signals per second exceeding the threshold voltage indicates the intensity of the X-ray exceeding the energy corresponding to the threshold voltage. In the following, the number of pulse signals per second exceeding the threshold voltage, which is detected by each pulse detection circuit 32, is also referred to as “X-ray detection amount”.

The standard line sensor as shown in FIGS. 3A and 3B, a time delay integration (TDI) line sensor, or an area sensor can be used as the X-ray detector 30. In a case where the X-ray detector 30 is the line sensor, the inspection object W is caused to be moved by using the transport unit 10 to enable the detection of the X-ray that passes through the inspection object W in the inspection region. Further, in a case where the X-ray detector 30 is the area sensor, the inspection object W is caused to be stationary to enable the detection of the X-ray that passes through the inspection object W in the inspection region.

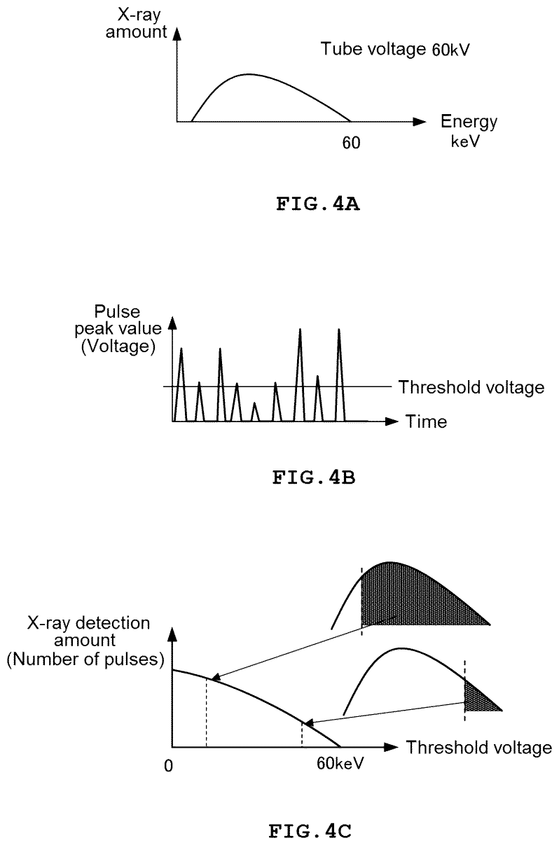

FIG. 4A is a graph schematically showing an energy distribution of the X-rays output from the X-ray generation source 20 in a case where the tube voltage of the X-ray tube 22 is 60 kV. Here, in a case where the tube voltage of the X-ray tube 22 is x [kV], a maximum value of the energy of the X-rays output from the X-ray generation source 20 is x [keV].

As shown in FIG. 4B, the pulse signals with various peak values according to various energies of the X-rays output from the X-ray generation source 20 are input to each pulse detection circuit 32 of the X-ray detector 30 from the X-ray detection element 31.

FIG. 4C is a graph schematically showing the X-ray detection amount obtained by sweeping the threshold voltage. Here, the threshold voltage is converted and shown in terms of the energy [keV] of the X-ray. That is, the X-ray detection amount of each pulse detection circuit array 33 is proportional to an area equal to or larger than the energy corresponding to the threshold voltage in the graph of the energy distribution of the X-rays as shown in FIG. 4A.

The radiation quality variable body 100 is a resin plate that is set up in the inspection region during the calibration mode instead of the inspection object W during an inspection mode. The calibration mode is an operation mode in which abnormal pixel information to specify an abnormal pixel and calibration information to perform energy calibration of pixels are acquired. Further, the inspection mode is an operation mode in which a normal inspection is performed on the inspection object W.

An example of the radiation quality variable body 100 that changes the energy (radiation quality) of the X-rays output from the X-ray generation source 20 includes a polyethylene terephthalate (PET) resin plate, a polyvinyl chloride (PVC) resin plate, or a barium-containing resin plate (for example, barium sulfate-containing resin plate).

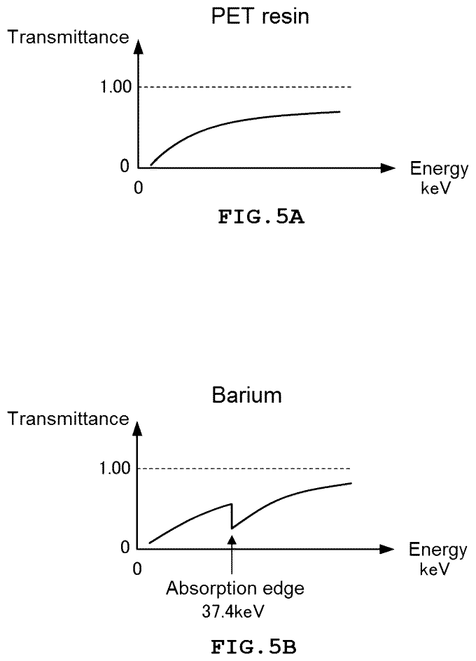

FIGS. 5A and 5B are graphs schematically showing an X-ray transmittance of a PET resin and barium. As shown in FIG. 5A, the X-ray transmits through the PET resin well as the energy of the X-ray is higher. On the other hand, as shown in FIG. 5B, as an overall tendency, the X-ray transmits through barium well as the energy of the X-ray is higher, but the transmittance is discontinuously reduced at 37.4 keV. This is because barium has an absorption edge of 37.4 keV.

The barium-containing resin plate is obtained by kneading a barium sulfate into the PET resin, for example.

The barium-containing resin plate obtained as described above exhibits intermediate X-ray transmission characteristics between those of the PET resin and barium, and retains the change in the X-ray transmittance near the absorption edge of barium.

An element having the absorption edge at around 30 keV is iodine, silver, or the like, in addition to barium. A resin plate containing these elements can also be used as the radiation quality variable body 100 according to the present embodiment.

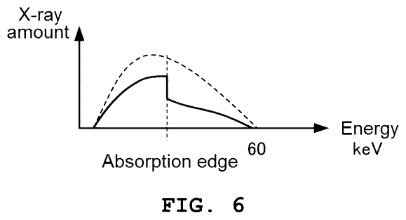

FIG. 6 schematically shows the energy distribution (broken line) of the X-rays output from the X-ray generation source 20 and an energy distribution (solid line) of the X-rays output from the X-ray generation source 20 and transmitted through the barium-containing resin plate. As described above, the energy distribution of the X-rays reaching the X-ray detector 30 is clearly different depending on whether the barium-containing resin plate is present.

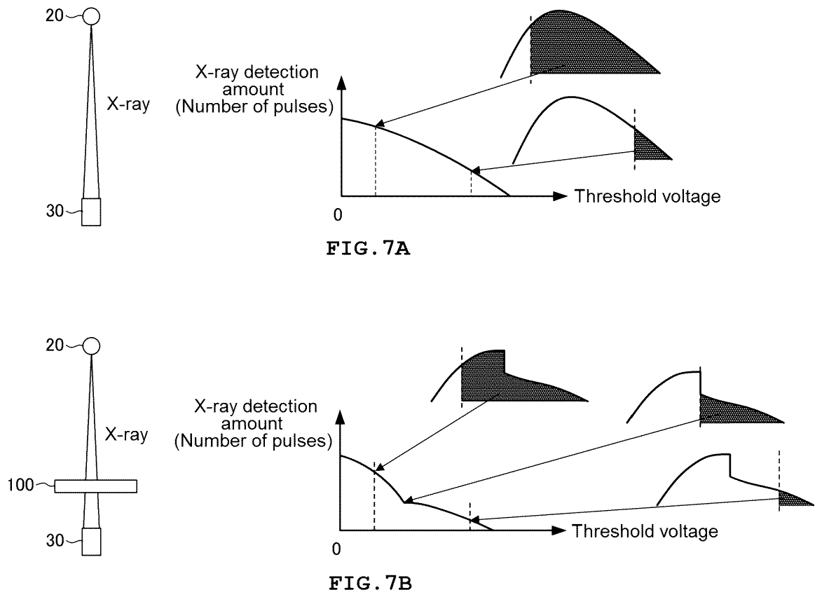

FIG. 7A is a graph schematically showing the X-ray detection amount obtained by sweeping the threshold voltage set in each pulse detection circuit 32 in a case where the barium-containing resin plate is not set up in the inspection region between the X-ray generation source 20 and the X-ray detector 30. On the other hand, FIG. 7B is a graph schematically showing the X-ray detection amount obtained by sweeping the threshold voltage set in each pulse detection circuit 32 in a case where the barium-containing resin plate as the radiation quality variable body 100 is set up in the inspection region between the X-ray generation source 20 and the X-ray detector 30. In the graph of the X-ray detection amount in FIG. 7B, it can be seen that a discontinuous change appears in an inclination of the X-ray detection amount with respect to the threshold voltage, which is one of control parameters described below, reflecting the absorption edge of barium. The inclination of the X-ray detection amount with respect to the control parameter refers to a ratio of a change amount of the X-ray detection amount to a minute change amount of the control parameter, that is, a value obtained by performing a first-order differentiation on the X-ray detection amount with the control parameter.

The control unit 50 controls the transport speed, a transport interval, or the like of the inspection object W by the transport belt 11 in the transport unit 10. Further, the control unit 50 controls X-ray irradiation intensity or an irradiation period by the X-ray generation source 20, or controls an X-ray detection cycle by the X-ray detector 30, a detection period of the inspection object W, and the like in accordance with the transport speed of the inspection object W.

Further, the control unit 50 includes a mode selection unit 51, an image data generation unit 52, a correction unit 53, a determination unit 54, a control parameter control unit 55, a storage unit 56, an abnormal pixel information output unit 57, a control parameter value specifying unit 58, and a calibration information output unit 59.

The mode selection unit 51 switches the operation mode of the X-ray inspection device 1 between the inspection mode and the calibration mode. For example, the mode selection unit 51 selects the operation mode of the X-ray inspection device 1 in accordance with an operation input to the operation unit 46 by an operator.

The image data generation unit 52, the correction unit 53, and the determination unit 54 are configured mainly for the inspection mode. The control parameter control unit 55, the storage unit 56, the abnormal pixel information output unit 57, the control parameter value specifying unit 58, and the calibration information output unit 59 are configured mainly for the calibration mode.

The image data generation unit 52 takes in, at each predetermined cycle, the X-ray detection amount output from the X-ray detector 30 and the information on the threshold voltage set by the control unit 50 to generate, for each different wavelength region, image data of the inspection object W consisting of two-dimensional position information, which is decided by a passing direction of the inspection object W and a pixel arrangement direction, and a signal processing result for each two-dimensional position.

The correction unit 53 corrects, for the image data generated by the image data generation unit 52, a deviation in image density characteristics from ideal characteristics, which is caused by a difference in a distance from the X-ray generation source 20 to each pixel of the X-ray detector 30, using a known method disclosed in Japanese Patent No. 6717784, for example.

The determination unit 54 performs a quality inspection that determines the presence or absence of a foreign matter in the inspection object W, based on the image data corrected by the correction unit 53 and a preset pass/fail determination criterion, to determine the pass/fail of the inspection object W. For example, the determination unit 54 executes, on the image data corrected by the correction unit 53, image processing such as filtering for extracting the foreign matter information as a foreign matter extraction image in an emphasized manner to enable the presence/absence detection of the foreign matter contained into the inspection object W. An example of a filter for emphasizing the foreign matter information includes a feature extraction filter such as a differential filter (Roberts filter, Prewitt filter, or Sobel filter) or a Laplacian filter. A determination result by the determination unit 54 is displayed on the display unit 45.

The control parameter control unit 55 performs control of changing a value of the control parameter to cause the number of pulse signals exceeding the threshold voltage to change. For example, the control parameter is any one of the threshold voltage, the tube voltage of the X-ray tube 22, or a type of the radiation quality variable body 100.

The storage unit 56 stores, for each pixel, a correspondence relationship between the value of the control parameter controlled by the control parameter control unit 55 and the number of pulse signals (X-ray detection amount) detected by the pulse detection circuit array 33.

The abnormal pixel information output unit 57 generates abnormal pixel information to specify a pixel (hereinafter also simply referred to as “abnormal pixel”) that outputs an abnormal X-ray detection amount, based on the correspondence relationship between the value of the control parameter and the X-ray detection amount of each pixel, the correspondence relationship being read out from the storage unit 56, and outputs the generated abnormal pixel information to the storage unit 56 or the display unit 45.

The control parameter value specifying unit 58 specifies, for each pixel, the threshold voltage at which the inclination of the X-ray detection amount of each pixel, which is read out from the storage unit 56, with respect to the control parameter changes discontinuously. Alternatively, the control parameter value specifying unit 58 specifies, for each pixel, a minimum threshold voltage at which the X-ray detection amount of each pixel, which is read out from the storage unit 56, is smaller than a predetermined threshold value ε and is substantially zero. Alternatively, the control parameter value specifying unit 58 specifies, for each pixel, a maximum tube voltage at which the X-ray detection amount of each pixel, which is read out from the storage unit 56, is smaller than the predetermined threshold value ε and is substantially zero. Here, the term “substantially zero” is used because assumption is made that the X-ray detection amount may not be exactly zero due to the influence of noise or the like of the X-ray detector 30. For example, the constant threshold value ε is decided, and it can be stated that “X-ray detection amount<ε”.

The calibration information output unit 59 outputs the threshold voltage specified by the control parameter value specifying unit 58 in association with a known absorption edge of the radiation quality variable body 100, as the calibration information for each pixel. Alternatively, the calibration information output unit 59 outputs the threshold voltage specified by the control parameter value specifying unit 58 in association with the tube voltage, as the calibration information for each pixel. Alternatively, the calibration information output unit 59 outputs the tube voltage specified by the control parameter value specifying unit 58 in association with the threshold voltage, as the calibration information for each pixel. For example, the calibration information output unit 59 outputs the calibration information to the storage unit 56 or the display unit 45.

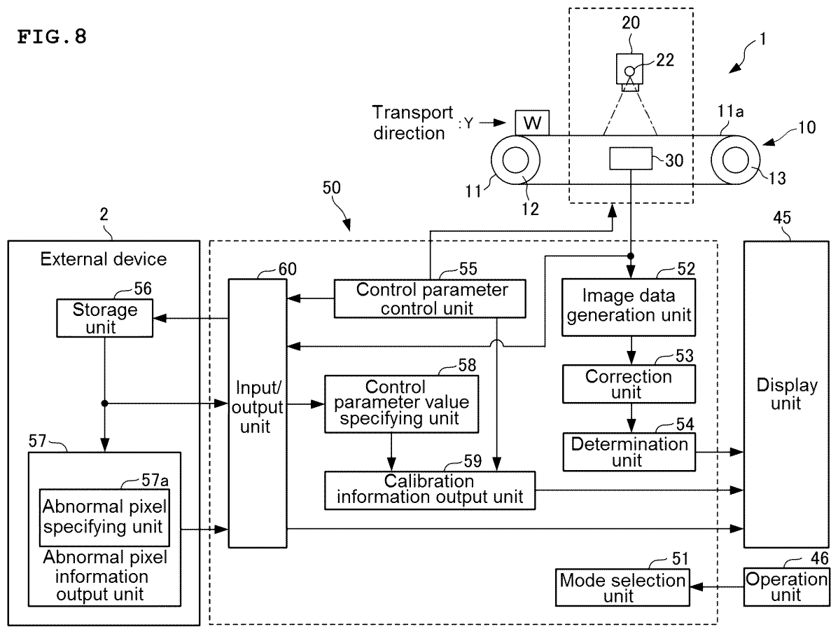

As shown in FIG. 8, the X-ray inspection device 1 according to the present embodiment may include an input/output unit 60 that can be connected to an external device 2. The external device 2 includes the storage unit 56 and the abnormal pixel information output unit 57 described above.

That is, in the configuration of FIG. 8, the storage unit 56 stores, for each pixel, the correspondence relationship between the value of the control parameter controlled by the control parameter control unit 55 and the X-ray detection amount of each pixel, which is input via the input/output unit 60. Further, the storage unit 56 outputs the X-ray detection amount of each pixel to the control parameter value specifying unit 58 via the input/output unit 60.

Further, in the configuration of FIG. 8, the abnormal pixel information output unit 57 generates the abnormal pixel information to specify the abnormal pixel, based on the correspondence relationship between the value of the control parameter and the X-ray detection amount of each pixel, the correspondence relationship being read out from the storage unit 56, and outputs the generated abnormal pixel information to the display unit 45 via the input/output unit 60.

### Method 1

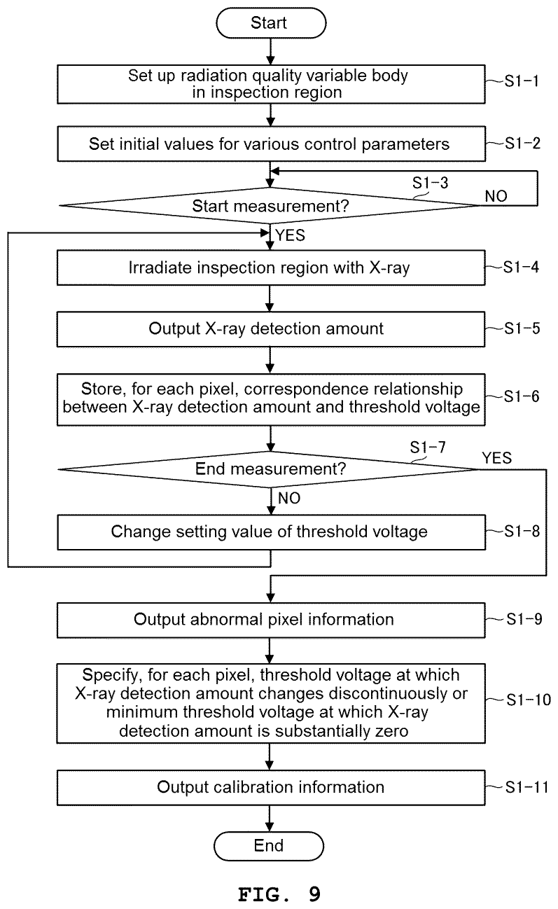

Hereinafter, Method 1 of Acquiring the X-Ray Detection amount with a configuration in which a variable control parameter is the threshold voltage will be described with reference to a flowchart of FIG. 9.

First, the operator sets up the radiation quality variable body 100, which has a known absorption edge, such as the barium-containing resin plate, in the inspection region (step S1-1). The setup of the radiation quality variable body 100 in the inspection region may be performed by implementation of a dedicated replacement mechanism (not shown) in the X-ray inspection device 1, instead of being performed by the operator. Further, the radiation quality variable body 100 may be transported by the transport unit 10 to be set up in the inspection region. Alternatively, the radiation quality variable body 100 may not be set up in the inspection region through which the inspection object W.

Next, the control parameter control unit 55 sets initial values for various control parameters in accordance with the operation input to the operation unit 46 by the operator (step S1-2). For example, in step S1-2, the tube voltage of the X-ray tube 22 is set to a predetermined value, and the threshold voltage of the X-ray detector 30 is set to E1.

Next, in a case where the operator performs, on the operation unit 46, the operation input to issue an instruction to start measurement (step S1-3: YES), the X-ray generation source 20 irradiates the inspection region with the X-ray (step S1-4).

Next, the X-ray detector 30 outputs the X-ray detection amount of the X-ray passing through the inspection region (X-ray detection step S1-5).

Next, the storage unit 56 stores, for each pixel, a correspondence relationship between the X-ray detection amount output from the X-ray detector 30 and the threshold voltage currently set as the variable control parameter (storage step S1-6).

Next, in a case where the operator does not perform, on the operation unit 46, the operation input to issue an instruction to end the measurement (step S1-7: NO), pieces of processing of step S1-8 and subsequent steps are executed.

On the other hand, in a case where the operator performs, on the operation unit 46, the operation input to issue the instruction to end the measurement (step S1-7: YES), pieces of processing of step S1-9 and subsequent steps are executed.

In step S1-8, the control parameter control unit 55 sets the threshold voltage, which is the variable control parameter, to a new value (step S1-8). The pieces of processing of step S1-4 and subsequent steps are executed again.

In step S1-9, the abnormal pixel information output unit 57 outputs the abnormal pixel information to specify the abnormal pixel that outputs the abnormal X-ray detection amount, based on the correspondence relationship between the value of the control parameter and the X-ray detection amount of each pixel, the correspondence relationship being read out from the storage unit 56 (abnormal pixel information output step S1-9).

Pieces of processing of steps S1-10 and S1-11 will be described below.

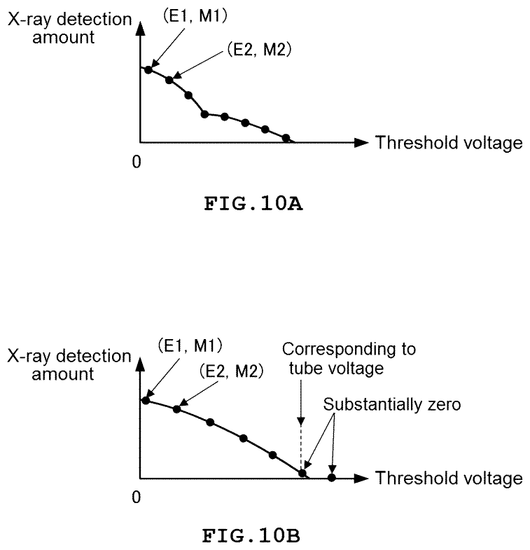

With the processing shown in the flowchart of FIG. 9, a correspondence relationship between the threshold voltage and the X-ray detection amount, as shown in FIGS. 10A and 10B, is obtained for each pixel. FIG. 10A shows a measurement result of the X-ray detection amount in a case where the radiation quality variable body 100 is set up in the inspection region. On the other hand, FIG. 10B shows a measurement result of the X-ray detection amount in a case where the radiation quality variable body 100 is not set up in the inspection region. Here, the X-ray detection amount obtained in a case of the threshold voltage of E1 is assumed to be M1, and the X-ray detection amount obtained in a case of the threshold voltage of E2 is assumed to be M2. The number of threshold voltages set in the X-ray detector 30 in the above processing is one or more, and the larger the number of threshold voltages, the more desirable.

### Method 2

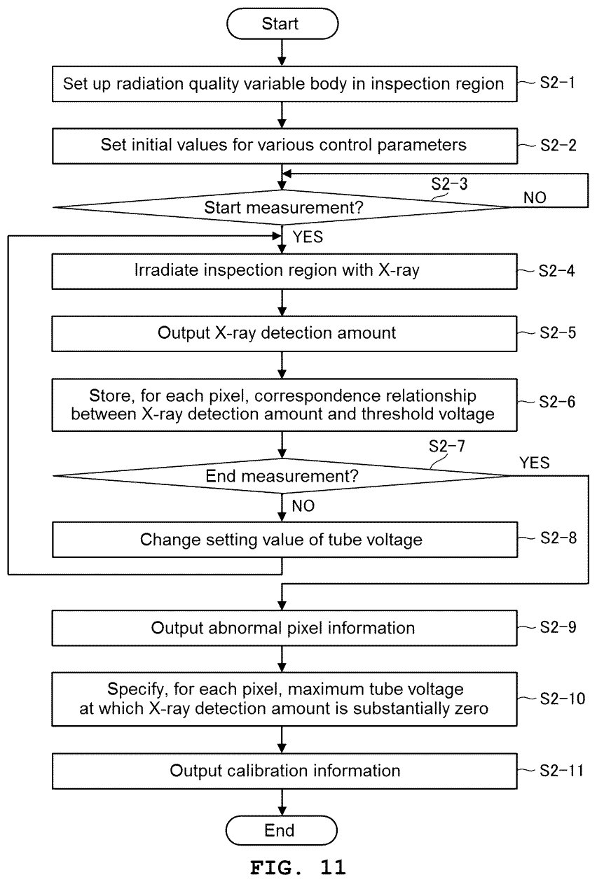

Hereinafter, Method 2 of acquiring the X-ray detection amount with a configuration in which the variable control parameter is the tube voltage will be described with reference to a flowchart of FIG. 11.

First, the operator sets up the radiation quality variable body 100, which has a known absorption edge, such as the barium-containing resin plate, in the inspection region (step S2-1). The setup of the radiation quality variable body 100 in the inspection region may be performed by implementation of a dedicated replacement mechanism (not shown) in the X-ray inspection device 1, instead of being performed by the operator. Further, the radiation quality variable body 100 may be transported by the transport unit to be set up set up in the inspection region. Alternatively, the radiation quality variable body 100 may not be set up in the inspection region through which the inspection object W.

Next, the control parameter control unit 55 sets initial values for various control parameters in accordance with the operation input to the operation unit 46 by the operator (step S2-2). For example, in step S2-2, the threshold voltage of each pixel is set to a predetermined value, and the tube voltage of the X-ray tube 22 is set to V1.

Next, in a case where the operator performs, on the operation unit 46, the operation input to issue an instruction to start measurement (step S2-3: YES), the X-ray generation source 20 irradiates the inspection region with the X-ray (step S2-4).

Next, the X-ray detector 30 outputs the X-ray detection amount of the X-ray passing through the inspection region (X-ray detection step S2-5).

Next, the storage unit 56 stores, for each pixel, a correspondence relationship between the X-ray detection amount output from the X-ray detector 30 and the tube voltage currently set as the variable control parameter (storage step S2-6).

Next, in a case where the operator does not perform, on the operation unit 46, the operation input to issue an instruction to end the measurement (step S2-7: NO), pieces of processing of step S2-8 and subsequent steps are executed.

On the other hand, in a case where the operator performs, on the operation unit 46, the operation input to issue the instruction to end the measurement (step S2-7: YES), pieces of processing of step S2-9 and subsequent steps are executed.

In step S2-8, the control parameter control unit 55 sets the tube voltage, which is the variable control parameter, to a new value (step S2-8). The pieces of processing of step S2-4 and subsequent steps are executed again.

In step S2-9, the abnormal pixel information output unit 57 outputs the abnormal pixel information to specify the abnormal pixel that outputs the abnormal X-ray detection amount, based on the correspondence relationship between the value of the control parameter and the X-ray detection amount of each pixel, the correspondence relationship being read out from the storage unit 56 (abnormal pixel information output step S2-9).

Pieces of processing of steps S2-10 and S2-11 will be described below.

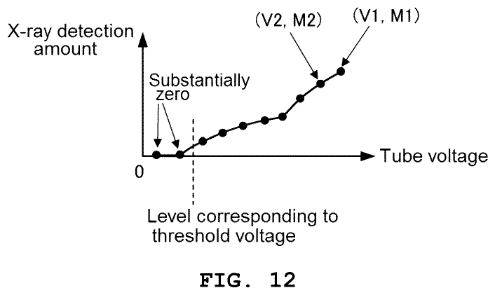

With the processing shown in the flowchart of FIG. 11, a correspondence relationship between the tube voltage and the X-ray detection amount, as shown in FIG. 12, is obtained for each pixel. Here, the X-ray detection amount obtained in a case of the tube voltage of V1 is assumed to be M1, and the X-ray detection amount obtained in a case of the tube voltage of V2 is assumed to be M2. In a case where the tube voltage is x [kV], a maximum energy generated from the X-ray tube 22 is x [keV]. Therefore, in a case where the threshold voltage corresponds to y [keV] and x<y is satisfied, the X-ray detection amount is smaller than the predetermined threshold value ε and is substantially zero. Here, the term “substantially zero” is used because assumption is made that the X-ray detection amount may not be exactly zero due to the influence of noise or the like of the X-ray detector 30. For example, the constant threshold value ε is decided, and it can be stated that “X-ray detection amount<ε”. The number of tube voltages set in the X-ray tube 22 in the above processing is one or more, and the larger the number of tube voltages, the more desirable.

### Method 3

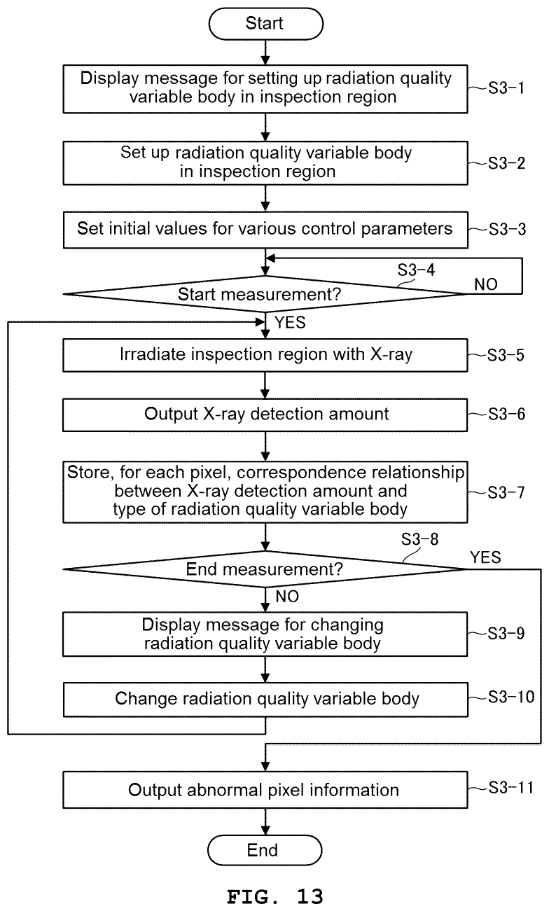

Hereinafter, Method 3 of acquiring the X-ray detection amount with a configuration in which the variable control parameter is the type of the radiation quality variable body 100 will be described with reference to a flowchart of FIG. 13.

First, the control parameter control unit 55 displays, on the display unit 45, a message urging the operator to set up the radiation quality variable body 100 (resin plate s1) in the inspection region (step S3-1).

Next, the operator sets up the resin plate s1 in the inspection region (step S3-2). Alternatively, the control parameter control unit 55 may control a dedicated replacement mechanism (not shown) implemented in the X-ray inspection device 1 to set up the resin plate s1 in the inspection region. Alternatively, the control parameter control unit 55 may control the transport unit 10 to transport, to the inspection region, the resin plate s1 to set up the resin plate s1 in the inspection region.

Next, the control parameter control unit 55 sets initial values for various control parameters in accordance with the operation input to the operation unit 46 by the operator (step S3-3). In step S3-3, the threshold voltage of each pixel and the tube voltage of the X-ray tube 22 are set to the predetermined values, respectively.

Next, in a case where the operator performs, on the operation unit 46, the operation input to issue an instruction to start measurement (step S3-4: YES), the X-ray generation source 20 irradiates the inspection region with the X-ray (step S3-5).

Next, the X-ray detector 30 outputs the X-ray detection amount of the X-ray passing through the inspection region (X-ray detection step S3-6).

Next, the storage unit 56 stores, for each pixel, a correspondence relationship between the X-ray detection amount output from the X-ray detector 30 and the type of the radiation quality variable body 100 currently set as the variable control parameter (storage step S3-7).

Next, in a case where the operator does not perform, on the operation unit 46, the operation input to issue an instruction to end the measurement (step S3-8: NO), pieces of processing of step S3-9 and subsequent steps are executed.

On the other hand, in a case where the operator performs, on the operation unit 46, the operation input to issue the instruction to end the measurement (step S3-8: YES), processing of step S3-11 is executed.

In step S3-9, the control parameter control unit 55 displays, on the display unit 45, a message urging the operator to change the type of the radiation quality variable body 100, which is the variable control parameter, that is, to set up a new resin plate in the inspection region (step S3-9).

Next, the operator removes the resin plate currently set up in the inspection region and sets up the new resin plate in the inspection region (step S3-10). Alternatively, the control parameter control unit 55 may control a dedicated replacement mechanism (not shown) implemented in the X-ray inspection device 1 to remove the resin plate currently set up in the inspection region and set up the new resin plate in the inspection region. Alternatively, the control parameter control unit 55 may control the transport unit 10 to transport, to the outside of the inspection region, the resin plate currently set up in the inspection region and transport, to the inspection region, the new resin plate to set up the new resin plate in the inspection region. The pieces of processing of step S3-5 and subsequent steps are executed again.

In step S3-11, the abnormal pixel information output unit 57 outputs the abnormal pixel information to specify the abnormal pixel that outputs the abnormal X-ray detection amount, based on the correspondence relationship between the value of the control parameter and the X-ray detection amount of each pixel, the correspondence relationship being read out from the storage unit 56 (abnormal pixel information output step S3-11).

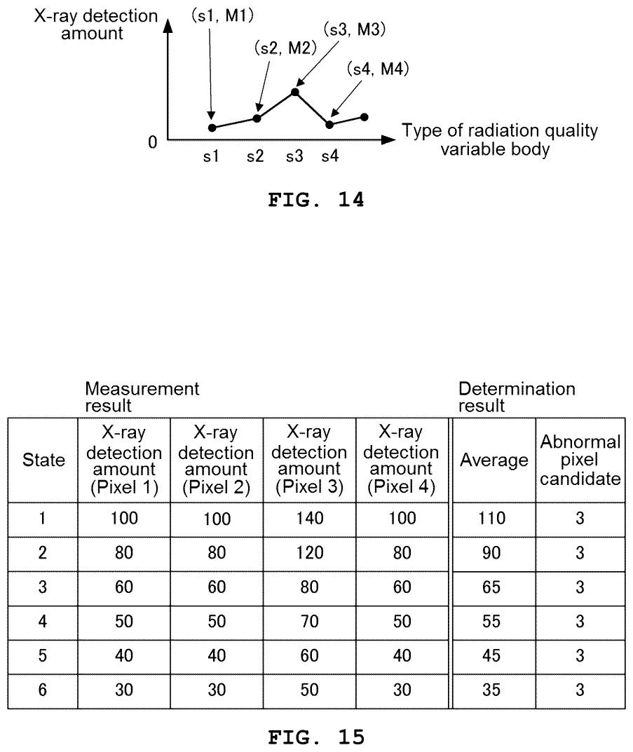

With the processing shown in the flowchart of FIG. 13, a correspondence relationship between the type of the radiation quality variable body 100 and the X-ray detection amount, as shown in FIG. 14, is obtained for each pixel. Here, the X-ray detection amounts obtained in a case of the types of the radiation quality variable body 100 of resin plates s1, s2, s3, and s4 are assumed to be M1, M2, M3, and M4, respectively. As an example, the resin plate s1 is the barium-containing resin plate, the resin plate s2 is a relatively thick PET resin plate, the resin plate s3 is a relatively thin PET resin plate, and the resin plate s4 is a PVC resin plate. The number of types of the radiation quality variable body 100 set up in the inspection region in the above processing is one or more, and the larger the number of types of the radiation quality variable body 100, the more desirable.

Hereinafter, an example of processing of a method of specifying the abnormal pixel by the abnormal pixel information output unit 57 will be described.

For example, the abnormal pixel information output unit 57 displays, on the display unit 45, a table or a graph showing the measurement result of the X-ray detection amount obtained by the X-ray detector 30 as the abnormal pixel information to allow the operator to specify the abnormal pixel through visual determination.

FIG. 15 shows an example of the table displayed on the display unit 45 by the abnormal pixel information output unit 57. Measurement results shown in a column on a left side of the table in FIG. 15 indicate, for each pixel, a correspondence relationship between states (for example, one or more threshold voltages) corresponding to certain values of the variable control parameter and measured X-ray detection amounts.

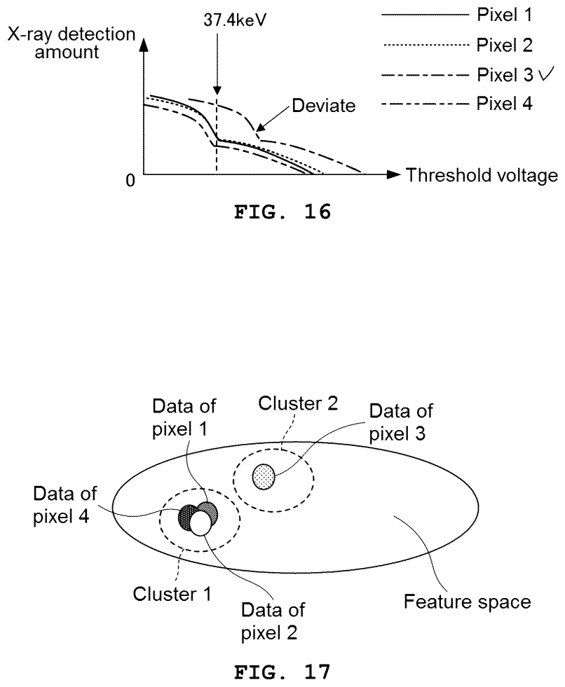

FIG. 16 shows an example of a graph displayed on the display unit 45 by the abnormal pixel information output unit 57. FIG. 16 shows measurement results of the X-ray detection amount for a plurality of pixels in a case where the variable control parameter is the threshold voltage. From this graph, it can be visually checked that the measurement result of the X-ray detection amount of a pixel 3 is abnormal.

Alternatively, the abnormal pixel information output unit 57 may include an abnormal pixel specifying unit 57a that automatically specifies the abnormal pixel, and may output, as the abnormal pixel information, a number or position of the abnormal pixel specified by the abnormal pixel specifying unit 57a. For example, the abnormal pixel specifying unit 57a automatically specifies the abnormal pixel, based on an automatic determination criterion, for each state corresponding to the certain value of the variable control parameter.

For example, the automatic determination criterion is a representative value obtained from the X-ray detection amounts of all pixels in each state. As shown in determination results in a column on a right side of the table in FIG. 15, for example, an average value of the X-ray detection amounts obtained in each state can be used as the representative value of all the pixels.

In this case, for example, the abnormal pixel specifying unit 57a specifies, as the abnormal pixel, a pixel that outputs the X-ray detection amount with a largest difference from the average value, or a pixel that outputs the X-ray detection amount with a difference from the average value equal to or larger than a predetermined threshold value.

For example, it can be seen that the X-ray detection amount of the pixel 3 deviates the most from the average value in all of states 1 to 6 shown in FIG. 15. Therefore, the abnormal pixel specifying unit 57a specifies the pixel 3 as the abnormal pixel.

Further, for example, it can be seen that the X-ray detection amount of the pixel 3 deviates from the average value by 15 or more in all of the states 1 to 6 shown in FIG. 15. Therefore, in a case where the predetermined threshold value is 15, the abnormal pixel specifying unit 57a specifies the pixel 3 as the abnormal pixel.

The automatic determination criterion may be set to various values by the operator using the operation unit 46.

Further, the abnormal pixel specifying unit 57a may prepare, for each pixel, a vector that collects the X-ray detection amounts of all of the states, which correspond to the certain value of the variable control parameter, to automatically classify the abnormal pixel and a normal pixel using machine learning.

The machine learning executed by the abnormal pixel specifying unit 57a is performed based on, for example, a clustering method such as a self-organizing map, a density-based spatial clustering of applications with noise (DBSCAN) method, or a t-distributed stochastic neighbor embedding (t-SNE) method. The clustering method is to classify data in a feature space based on a distance (or degree of similarity) between the data. Further, the machine learning executed by the abnormal pixel specifying unit 57a is not limited to the above clustering methods, and may be performed based on a method using a classifier, such as a support vector machine or a random forest.

FIG. 17 is a diagram for describing the clustering method by the abnormal pixel specifying unit 57a. For example, in the example shown in FIG. 15, data of the X-ray detection amount of pixels 1, 2, and 4 belong to a cluster 1, and data of the X-ray detection amount of the pixel 3 belongs to a cluster 2. In this manner, a cluster to which a large number of data belong and a cluster to which a small number of data belong are decided. For example, the abnormal pixel specifying unit 57a determines that a pixel corresponding to the data of the X-ray detection amount belonging to the large cluster is the normal pixel, and determines that a pixel corresponding to the data of the X-ray detection amount belonging to the small cluster is the abnormal pixel.

As described above, with the output of the abnormal pixel information by the abnormal pixel information output unit 57, it is possible to urge the operator to take action such as setting the X-ray detector 30 not to use the abnormal pixel.

Hereinafter, operations of the control parameter value specifying unit 58 and the calibration information output unit 59 that acquire the calibration information to perform the energy calibration of the pixel will be described.

First, a case of a configuration in which the variable control parameter is the threshold voltage and the radiation quality variable body 100 having the absorption edge is used will be described.

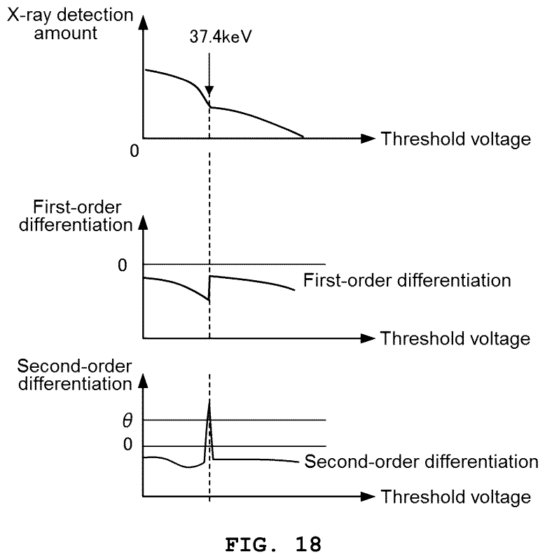

As shown in a graph of FIG. 18, a discontinuous change in the transmittance due to the influence of the absorption edge appears in a graph of the X-ray detection amount with respect to the threshold voltage, and the feature also appears in a first-order differentiation of the X-ray detection amount and a second-order differentiation of the X-ray detection amount. At the absorption edge, the first-order differentiation of the X-ray detection amount is discontinuous, and a value of the second-order differentiation of the X-ray detection amount is a significantly large value. For this reason, for example, in a case where an appropriate threshold value θ is decided, the threshold voltage at which the second-order differential value>θ can be specified in correspondence with the absorption edge (for example, 37.4 keV).

Therefore, the control parameter value specifying unit 58 performs the second-order differentiation on the X-ray detection amount with the threshold voltage, and uses the threshold value θ as described above to specify, for each pixel, the threshold voltage at which the inclination of the X-ray detection amount of each pixel, which is read out from the storage unit 56, with respect to the control parameter changes discontinuously.

Hereinafter, the calibration method of acquiring the calibration information with a configuration in which the variable control parameter is the threshold voltage and the radiation quality variable body 100 having the absorption edge is used will be described again with reference to the flowchart of FIG. 9.

In step S1-10, the control parameter value specifying unit 58 specifies, for each pixel, the threshold voltage at which the inclination of the X-ray detection amount of each pixel, which is read out from the storage unit 56, with respect to the control parameter changes discontinuously (control parameter value specifying step S1-10).

Next, the calibration information output unit 59 outputs, as the calibration information, the threshold voltage specified in the control parameter value specifying step S1-10 in association with the known absorption edge (calibration information output step S1-11).

On the other hand, for the calibration method of acquiring the calibration information with a configuration in which the variable control parameter is the threshold voltage and the radiation quality variable body 100 is not used, pieces of processing of the control parameter value specifying step S1-10 and the calibration information output step S1-li are as follows.

As shown in FIG. 10B, the control parameter value specifying unit 58 specifies, for each pixel, the minimum threshold voltage at which the X-ray detection amount of each pixel, which is read out from the storage unit 56, is smaller than the predetermined threshold value ε and is substantially zero (control parameter value specifying step S1-10). Accordingly, it is possible to take the correlation between the threshold voltage and the energy of the X-ray. Here, the term “substantially zero” is used because assumption is made that the X-ray detection amount may not be exactly zero due to the influence of noise or the like of the X-ray detector 30. For example, the constant threshold value ε is decided, and it can be stated that “X-ray detection amount<ε”. In a case where the tube voltage is x [kV], a maximum energy generated from the X-ray tube 22 is x [keV]. Therefore, in a case where the threshold voltage corresponds to y [keV] and x<y is satisfied, the X-ray detection amount is substantially zero.

Next, the calibration information output unit 59 outputs the threshold voltage specified by the control parameter value specifying unit 58 in association with the tube voltage, as the calibration information for each pixel (calibration information output step S1-11).

Further, the calibration method of acquiring the calibration information with a configuration in which the variable control parameter is the tube voltage will be described again with reference to the flowchart of FIG. 11.

In step S2-10, as shown in FIG. 12, the control parameter value specifying unit 58 specifies, for each pixel, the maximum tube voltage at which the X-ray detection amount of each pixel, which is read out from the storage unit 56, is smaller than the predetermined threshold value ε and is substantially zero (control parameter value specifying step S2-10). Accordingly, it is possible to take the correlation between the threshold voltage and the energy of the X-ray. Here, the term “substantially zero” is used because assumption is made that the X-ray detection amount may not be exactly zero due to the influence of noise or the like of the X-ray detector 30. For example, the constant threshold value ε is decided, and it can be stated that “X-ray detection amount<ε”.

Next, the calibration information output unit 59 outputs the tube voltage specified by the control parameter value specifying unit 58 in association with the threshold voltage, as the calibration information for each pixel (calibration information output step S2-11).

As described above, with the output of the calibration information to perform the energy calibration of the pixels by the calibration information output unit 59, it is possible to urge the operator to take action such as adjusting a gain of the abnormal pixel of the X-ray detector 30.

The accuracy of taking the correspondence between the energy of the X-ray and the threshold voltage, based on the tube voltage, depends on the accuracy of the tube voltage. Therefore, it is considered that taking the correspondence between the energy of the X-ray and the threshold voltage using the radiation quality variable body 100 having the absorption edge is more accurate than taking the correspondence between the energy of the X-ray and the threshold voltage based on the tube voltage.

The control unit 50 is, for example, configured by a control device such as a computer including a central processing unit (CPU), a graphics processing unit (GPU), a field programmable gate array (FPGA), a read only memory (ROM), a random access memory (RAM), a hard disk drive (HDD), and the like. For example, the control unit 50 can configure at least a part of the mode selection unit 51, the image data generation unit 52, the correction unit 53, the determination unit 54, the control parameter control unit 55, the abnormal pixel information output unit 57, the control parameter value specifying unit 58, or the calibration information output unit 59 in a software manner by executing a predetermined program using the CPU or the GPU. The above program is stored in the ROM or the HDD in advance. Alternatively, the above program may be provided or distributed in a state of being recorded on a computer-readable recording medium such as a compact disc or a DVD in an installable or executable form. Alternatively, the above program may be stored in a computer connected to a network such as the Internet, and provided or distributed by downloading the program via the network.

The display unit 45 is configured of, for example, a display device such as a liquid crystal display (LCD) or a cathode ray tube (CRT), and displays various types of information, such as the abnormal pixel information, various determination results, and measurement results, based on a display control signal from the control unit 50. The display unit 45 may have an operation function of the operation unit 46, such as a soft key on a display screen thereof.

The operation unit 46 is used to receive the operation input by the operator, and is configured of a user interface, such as a key, a push button, a switch, or the soft key on the display screen of the display unit 45, which is provided in a main body of the X-ray inspection device 1.

For example, with the operation input to the operation unit 46 by the operator, the operation mode of the X-ray inspection device 1 may be selected in the mode selection unit 51, or information (for example, the transport speed of the transport unit 10, a total number of inspections of the inspection object W, and a determination threshold value for determining the pass/fail of the inspection object W) necessary for a series of inspections, including information (for example, a product name) of the inspection object W, may be input.

As described above, the X-ray inspection device 1 according to the present embodiment acquires the correspondence relationship between the value of the control parameter to cause the number of pulse signals exceeding the predetermined threshold voltage to change, among the pulse signals with the peak value corresponding to the energy of the X-ray passing through the inspection region, and the X-ray detection amount detected by each pixel of the pulse detection circuit array 33. Further, the X-ray inspection device 1 according to the present embodiment can output the abnormal pixel information to specify the abnormal pixel, based on the correspondence relationship between the value of the control parameter and the X-ray detection amount detected by each pixel.

Further, in the X-ray inspection device 1 according to the present embodiment, in a case where the storage unit 56 and the abnormal pixel information output unit 57 are provided in the external device 2, the external device 2 may be connected via the input/output unit 60 only in a case where the abnormal pixel is specified at a time of product shipment, and thus it is possible to simplify the device main body.

Further, the X-ray inspection device 1 according to the present embodiment can output, using the radiation quality variable body 100 having the known absorption edge, the threshold voltage at which the inclination of the X-ray detection amount of each pixel with respect to the control parameter changes discontinuously in association with the known absorption edge, as the calibration information for each pixel.

Further, the X-ray inspection device 1 according to the present embodiment can output the minimum threshold voltage at which the X-ray detection amount of each pixel is smaller than the predetermined threshold value ε and is substantially zero in association with the tube voltage of the X-ray tube 22, as the calibration information for each pixel.

Further, the X-ray inspection device 1 according to the present embodiment can output the maximum tube voltage of the X-ray tube 22 at which the X-ray detection amount of each pixel is smaller than the predetermined threshold value c and is substantially zero in association with the threshold voltage, as the calibration information for each pixel.

That is, the X-ray inspection device 1 according to the present embodiment can output the calibration information to perform the energy calibration of each pixel of the X-ray detector 30 without using a radioactive substance that poses safety concerns.

### DESCRIPTION OF REFERENCE NUMERALS AND SIGNS

1: X-ray inspection device
2: external device
20: X-ray generation source
22: X-ray tube
23: filament
24: target
25: anode
30: X-ray detector
31: X-ray detection element
32, 321, 322, . . . , 32N: pulse detection circuit (pixel)
33: pulse detection circuit array (X-ray detection unit)
45: display unit
46: operation unit
50: control unit
55: control parameter control unit
56: storage unit
57: abnormal pixel information output unit
57a: abnormal pixel specifying unit
58: control parameter value specifying unit
59: calibration information output unit
60: input/output unit
100: radiation quality variable body
W: inspection object

What is claimed is:

1. An X-ray inspection device comprising:
an X-ray generation source that irradiates an inspection region with an X-ray;
an X-ray detector that detects the X-ray passing through the inspection region, the X-ray detector including an X-ray detection element that outputs a pulse signal with a peak value corresponding to an energy of the X-ray passing through the inspection region and an X-ray detection unit consisting of a plurality of pixels that detect the number of the pulse signals exceeding a predetermined threshold voltage, among the pulse signals output from the X-ray detection element;
a storage unit that stores, for each pixel, a correspondence relationship between a value of a control parameter to cause the number of the pulse signals exceeding the threshold voltage to change and the number of the pulse signals detected by respective pixels; and
an abnormal pixel information output unit that outputs abnormal pixel information to specify an abnormal pixel based on the correspondence relationship between the value of the control parameter and the number of the pulse signals detected by respective pixels, the correspondence relationship being read out from the storage unit.

2. An X-ray inspection device comprising:
an X-ray generation source that irradiates an inspection region with an X-ray;
an X-ray detector that detects the X-ray passing through the inspection region;
a display unit that displays various types of information; and
an input/output unit that is connectable to an external device,
wherein the X-ray detector includes
an X-ray detection element that outputs a pulse signal with a peak value corresponding to an energy of the X-ray passing through the inspection region,
an X-ray detection unit consisting of a plurality of pixels that detect the number of the pulse signals exceeding a predetermined threshold voltage, among the pulse signals output from the X-ray detection element, and
a control parameter control unit that performs control of changing a value of a control parameter to cause the number of the pulse signals exceeding the threshold voltage to change, and
the external device includes
a storage unit that stores, for each pixel, a correspondence relationship between the value of the control parameter controlled by the control parameter control unit and the number of the pulse signals detected by respective pixels, which is input via the input/output unit, and
an abnormal pixel information output unit that generates abnormal pixel information to specify an abnormal pixel, based on the correspondence relationship between the value of the control parameter and the number of the pulse signals detected by respective pixels, the correspondence relationship being read out from the storage unit, and outputs the abnormal pixel information to the display unit via the input/output unit.

3. The X-ray inspection device according to claim 1,
wherein the control parameter is the threshold voltage or a tube voltage of the X-ray generation source.

4. The X-ray inspection device according to claim 2,
wherein the control parameter is the threshold voltage or a tube voltage of the X-ray generation source.

5. The X-ray inspection device according to claim 1,
wherein the control parameter is any one of the threshold voltage, a tube voltage of the X-ray generation source, or a type of a radiation quality variable body set up in the inspection region.

6. The X-ray inspection device according to claim 2,
wherein the control parameter is any one of the threshold voltage, a tube voltage of the X-ray generation source, or a type of a radiation quality variable body set up in the inspection region.

7. The X-ray inspection device according to claim 5,
wherein the control parameter is the threshold voltage, and
the radiation quality variable body has a known absorption edge,
the X-ray inspection device further comprising:
a control parameter value specifying unit that specifies, for each pixel, the threshold voltage at which an inclination of the number of the pulse signals detected by respective pixels, which is read out from the storage unit, with respect to the control parameter changes discontinuously; and
a calibration information output unit that outputs the threshold voltage specified by the control parameter value specifying unit in association with the known absorption edge, as calibration information for respective pixels.

8. The X-ray inspection device according to claim 6,
wherein the control parameter is the threshold voltage, and
the radiation quality variable body has a known absorption edge,
the X-ray inspection device further comprising:
a control parameter value specifying unit that specifies, for each pixel, the threshold voltage at which an inclination of the number of the pulse signals detected by respective pixels, which is read out from the storage unit, with respect to the control parameter changes discontinuously; and
a calibration information output unit that outputs the threshold voltage specified by the control parameter value specifying unit in association with the known absorption edge, as calibration information for respective pixels.

9. The X-ray inspection device according to claim 3,
wherein the control parameter is the threshold voltage,
the X-ray inspection device further comprising:
a control parameter value specifying unit that specifies, for each pixel, a minimum threshold voltage at which the number of pulse signals detected by respective pixels, which is read out from the storage unit, is smaller than a predetermined value; and
a calibration information output unit that outputs the threshold voltage specified by the control parameter value specifying unit in association with the tube voltage, as calibration information for respective pixels.

10. The X-ray inspection device according to claim 4,
wherein the control parameter is the threshold voltage,
the X-ray inspection device further comprising:
a control parameter value specifying unit that specifies, for each pixel, a minimum threshold voltage at which the number of pulse signals detected by respective pixels, which is read out from the storage unit, is smaller than a predetermined value; and
a calibration information output unit that outputs the threshold voltage specified by the control parameter value specifying unit in association with the tube voltage, as calibration information for respective pixels.

11. The X-ray inspection device according to claim 3,
wherein the control parameter is the tube voltage,
the X-ray inspection device further comprising:
a control parameter value specifying unit that specifies, for each pixel, a maximum tube voltage at which the number of pulse signals detected by respective pixels, which is read out from the storage unit, is smaller than a predetermined value; and
a calibration information output unit that outputs the tube voltage specified by the control parameter value specifying unit in association with the threshold voltage, as calibration information for respective pixels.

12. The X-ray inspection device according to claim 4,
wherein the control parameter is the tube voltage,
the X-ray inspection device further comprising:
a control parameter value specifying unit that specifies, for each pixel, a maximum tube voltage at which the number of pulse signals detected by respective pixels, which is read out from the storage unit, is smaller than a predetermined value; and
a calibration information output unit that outputs the tube voltage specified by the control parameter value specifying unit in association with the threshold voltage, as calibration information for respective pixels.

13. The X-ray inspection device according to claim 5,
wherein the control parameter is the tube voltage,
the X-ray inspection device further comprising:
a control parameter value specifying unit that specifies, for each pixel, a maximum tube voltage at which the number of pulse signals detected by respective pixels, which is read out from the storage unit, is smaller than a predetermined value; and
a calibration information output unit that outputs the tube voltage specified by the control parameter value specifying unit in association with the threshold voltage, as calibration information for respective pixels.

14. The X-ray inspection device according to claim 6,
wherein the control parameter is the tube voltage,
the X-ray inspection device further comprising:
a control parameter value specifying unit that specifies, for each pixel, a maximum tube voltage at which the number of pulse signals detected by respective pixels, which is read out from the storage unit, is smaller than a predetermined value; and
a calibration information output unit that outputs the tube voltage specified by the control parameter value specifying unit in association with the threshold voltage, as calibration information for respective pixels.

15. A calibration method of an X-ray inspection device including an X-ray generation source that irradiates an inspection region with an X-ray, and
an X-ray detector that detects the X-ray passing through the inspection region, the X-ray detector including an X-ray detection element that outputs a pulse signal with a peak value corresponding to an energy of the X-ray passing through the inspection region and an X-ray detection unit consisting of a plurality of pixels that detect the number of the pulse signals exceeding a predetermined threshold voltage, among the pulse signals output from the X-ray detection element, the calibration method comprising:
a step of irradiating the inspection region with the X-ray;
an X-ray detection step of detecting the X-ray passing through the inspection region;
a storage step of storing, for each pixel, a correspondence relationship between a value of a control parameter to cause the number of the pulse signals exceeding the threshold voltage to change and the number of the pulse signals detected by respective pixels, in a storage unit; and
an abnormal pixel information output step of outputting abnormal pixel information to specify an abnormal pixel based on the correspondence relationship between the value of the control parameter and the number of the pulse signals detected by respective pixels, the correspondence relationship being read out from the storage unit.

16. A calibration method of an X-ray inspection device including an X-ray generation source that irradiates an inspection region with an X-ray, and
an X-ray detector that detects the X-ray passing through the inspection region, in which the X-ray detector includes
an X-ray detection element that outputs a pulse signal with a peak value corresponding to an energy of the X-ray passing through the inspection region, and
an X-ray detection unit consisting of a plurality of pixels that detect the number of the pulse signals exceeding a predetermined threshold voltage, among the pulse signals output from the X-ray detection element, the calibration method comprising:
a step of setting up a radiation quality variable body having a known absorption edge in the inspection region;
a step of irradiating the inspection region with the X-ray;
an X-ray detection step of detecting the X-ray passing through the inspection region;
a storage step of storing, for each pixel, a correspondence relationship between a value of a control parameter to cause the number of the pulse signals exceeding the threshold voltage to change and the number of the pulse signals detected by respective pixels, in a storage unit;
a control parameter value specifying step of specifying, for each pixel, the threshold voltage at which an inclination of the number of the pulse signals detected by respective pixels, which is read out from the storage unit, with respect to the control parameter changes discontinuously; and
a calibration information output step of outputting the threshold voltage specified in the control parameter value specifying step in association with the known absorption edge, as calibration information for respective pixels.

17. The calibration method according to claim 15,
wherein the control parameter is any of the threshold voltage, a tube voltage of the X-ray generation source, or a type of a radiation quality variable body set up in the inspection region.

18. The calibration method according to claim 16,
wherein the control parameter is any of the threshold voltage, a tube voltage of the X-ray generation source, or a type of a radiation quality variable body set up in the inspection region.

19. The calibration method according to claim 17,
wherein the control parameter is the threshold voltage, and
the radiation quality variable body has a known absorption edge,
the calibration method further comprising:
a control parameter value specifying step of specifying, for each pixel, the threshold voltage at which an inclination of the number of the pulse signals detected by respective pixels, which is read out from the storage unit, with respect to the control parameter changes discontinuously; and
a calibration information output step of outputting the threshold voltage specified in the control parameter value specifying step in association with the known absorption edge, as calibration information for respective pixels.

20. The calibration method according to claim 18,
wherein the control parameter is the threshold voltage, and
the radiation quality variable body has a known absorption edge,
the calibration method further comprising:
a control parameter value specifying step of specifying, for each pixel, the threshold voltage at which an inclination of the number of the pulse signals detected by respective pixels, which is read out from the storage unit, with respect to the control parameter changes discontinuously; and
a calibration information output step of outputting the threshold voltage specified in the control parameter value specifying step in association with the known absorption edge, as calibration information for respective pixels.
